(19) United States
(12) Patent Application Publication
(10) Pub. No.: US 2006/0020661 A1
(43) Pub. Date: Jan. 26, 2006

(54) Apparatus and method for displaying content

(75) Inventors: Eun-hee Rhim, Suwon-si (KR); Kwang-yun Na, Yongin-si (KR); Jong-hak Ahn, Suwon-si (KR); Soon-back Cha, Suwon-si (KR); Nam-soon Kim, Suwon-si (KR); Kee-wook Na, Anyang-si (KR); Do-jun Yang, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/188,033

(22) Filed: Jul. 25, 2005

(30) Foreign Application Priority Data
Jul. 24, 2004 (KR) 10-2004-0058074
Aug. 13, 2004 (KR) 10-2004-0063882

(51) Int. Cl. G06F 15/16

(52) U.S. Cl. 709/203; 709/202

(57) ABSTRACT

An apparatus and method for displaying contents are provided. The apparatus includes a device interface module automatically sensing a server connected to the display apparatus through a network and receiving content pushed according to a predetermined schedule and a control command from the server, a control and monitoring module receiving the control command from the device interface module, performing state control corresponding to the control command, and sensing a state change, a content processing module converting the content received from the device interface module into a format suitable for display, a display module outputting the content converted by the content processing module, and a device agent module analyzing information received through the device interface module and performing an operation according to the analyzed information.

### CROSS-REFERENCE TO RELATED APPLICATIONS

This application claims priority from Korean Patent Application Nos. 10-2004-0058074 and 10-2004-0063882 filed on filed on Jul. 24, 2004 and Aug. 13, 2004, respectively, in the Korean Intellectual Property Office, the disclosures of which are incorporated herein by reference in their entireties.

### BACKGROUND OF THE INVENTION

1. Field of the Invention

Apparatuses and methods consistent with the present invention relate to a service for displaying content, and more particularly, to efficiently providing content by supplying a plurality of display apparatuses and a single server which are connected through a network and perform predetermined message communication, and allowing the server to remotely control and monitor the display apparatuses.

2. Description of the Related Art

FIG. 1 is a schematic diagram of a conventional system 100 for providing a service of displaying content.

The conventional system 100 includes display apparatuses 110, 130, and 150 and servers 120, 140, and 160, which are connected to the display apparatuses 110, 130, and 150, respectively, to provide content. Content includes multimedia data such as music, images, motion pictures, and data having diverse text formats.

Various kinds of software programs are installed in or independent hardware containing these programs is mounted to each of the servers 120, 140, and 160 to convert content stored therein into a format suitable for the corresponding display apparatuses 110, 130, and 150 to output. Accordingly, the output format of the content selected by a server manager is converted using these software program, and the converted content is output by a display apparatus.

A display apparatus may include a function that allows a user to select content, receive the selected content from a server, and output the content. In this case, the display apparatus serves as a client.

FIG. 2 illustrates a method of providing a content display service between such a client and server.

In operation S210, a client connects with a server using address and port information of the server while the server is operating. In operation S220, the client requests a service from the server. In operation S230, the server retrieves the requested service and provides the service to the client.

According to a conventional system like that shown in FIG. 1, a separate server having a format conversion function is needed for each display apparatus and a server manager needs to select content to be output through the display apparatus. In addition, when the client-server structure shown in FIG. 2 is used, the server has difficulty in controlling a client display apparatus and monitoring changes in the physical state of the display apparatus. The server may control the display apparatus using Universal Plug-and-Play (UPnP) standard. In UPnP, a remote control and monitoring service is implemented based on the HyperText Markup Language (HTML). Accordingly, an HTML browser and parser are needed to analyze a message and hardware or software having HyperText Transfer Protocol (HTTP) functionality are needed to perform the UPnP protocol. However, messages or remote control commands are valid only when it defined in the UPnP protocol. As a result, there are a lot of restrictions on both the remote control commands and the method of monitoring the changes in state of the display apparatuses. Moreover, even when just a simple remote control command is performed, an HTTP server and HTML parser software are needed.

Therefore, to overcome these conventional problems, an apparatus and method for displaying content, which involves a server efficiently providing content to display apparatuses and remotely controlling and monitoring the display apparatuses, are desired.

### SUMMARY OF THE INVENTION

The present invention provides an apparatus and method for displaying contents, by which contents are automatically provided to a plurality of display apparatuses having a message communication function using a single server.

The present invention also provides an apparatus and method for displaying contents, by which a plurality of display apparatuses having a message communication function are remotely controlled and the change in a physical state of each display apparatus is monitored using a single server.

According to an aspect of the present invention, there is provided an apparatus for displaying contents, including a device interface module automatically sensing a server connected to the display apparatus through a network and receiving content pushed according to a predetermined schedule and a control command from the server, a control and monitoring module receiving the control command from the device interface module, performing state control corresponding to the control command, and sensing a state change, a content processing module converting the content received from the device interface module into a format suitable for display, a display module outputting the content converted by the content processing module, and a device agent module analyzing information received through the device interface module and performing an operation according to the analyzed information.

According to another aspect of the present invention, there is provided a server apparatus including a server interface module automatically sensing a display apparatus connected to the server through a network, extracting information on the display apparatus, and transmitting content and a control command for controlling the display apparatus to the display apparatus, a storage module storing the content and schedule information on a schedule in which the content is pushed to the display apparatus, a scheduling module managing the schedule information and pushing the content according to the schedule information, a user interface module providing a user interface allowing a user to input the schedule information and the control command for the display apparatus, and a server agent module analyzing information provided through the server interface module, performing an operation according to the analyzed information, and monitoring state information received from the display apparatus.

According to still another aspect of the present invention, there is provided a method of displaying contents, including automatically sensing a server connected through a network and receiving one of content pushed according to a predetermined schedule and a control command from the server, converting the received content into a format suitable for display, outputting the converted content, performing state control according to the received control command, and transmitting state information comprising one of a result of performing the state control and information on an output state of the content.

According to a further aspect of the present invention, there is provided a method of displaying contents, including receiving from a user one of schedule information on a schedule in which content is pushed to a display apparatus and a control command for the display apparatus, managing the schedule information, pushing the content to the display apparatus according to the schedule information, transmitting the control command to the display apparatus, and monitoring state information received from the display apparatus, the state information comprising one of a result of executing the control command and information on an output state of the content.

### BRIEF DESCRIPTION OF THE DRAWINGS

The above and other aspects of the present invention will become more apparent by describing in detail exemplary embodiments thereof with reference to the attached drawings in which:

FIG. 1 is a schematic diagram of a conventional system for providing a service of displaying content;

FIG. 2 illustrates a conventional method of providing a service between a client and a server;

FIG. 3 is a schematic diagram of a system for providing a service of displaying content according to an exemplary embodiment of the present invention;

FIG. 4 illustrates a display apparatus and a server for providing a service of displaying content according to an exemplary embodiment of the present invention;

FIG. 5 is a schematic flowchart of a procedure performed by a display apparatus to display content according to an exemplary embodiment of the present invention;

FIG. 6 is a schematic flowchart of a procedure performed by a server to display content according to an exemplary embodiment of the present invention;

FIG. 7 illustrates a service registration procedure according to an exemplary embodiment of the present invention;

FIG. 8 illustrates a procedure for performing a pull mode of service according to an exemplary embodiment of the present invention;

FIG. 9 is illustrates a procedure for performing a push mode of service according to an exemplary embodiment of the present invention;

FIG. 10 illustrates a procedure for performing a remote control service according to an exemplary embodiment of the present invention;

FIGS. 11A and 11B illustrate procedures for finishing a service according to an exemplary embodiment of the present invention; and

FIG. 12 is a block diagram of a remote control and monitoring system according to an exemplary embodiment of the present invention.

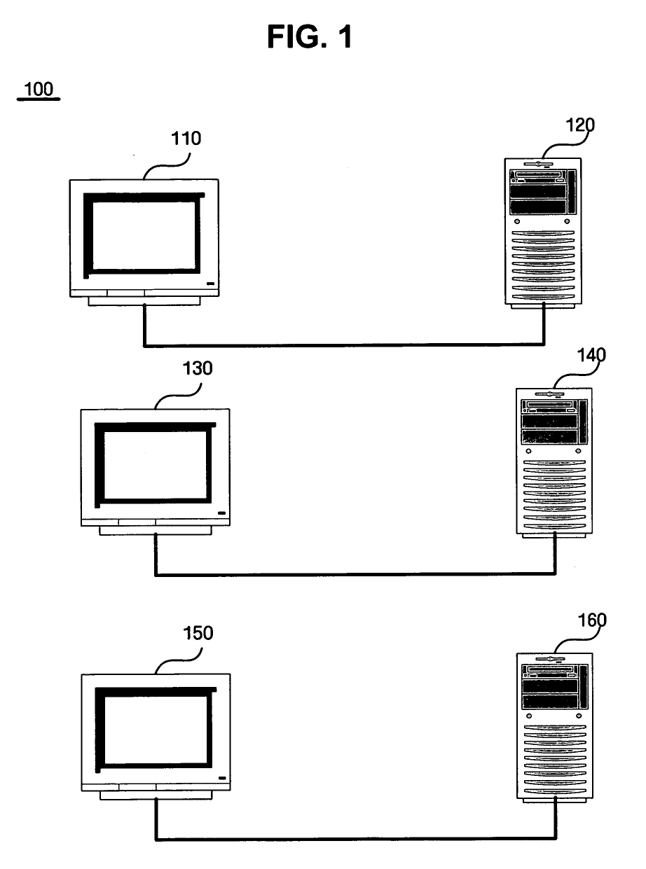

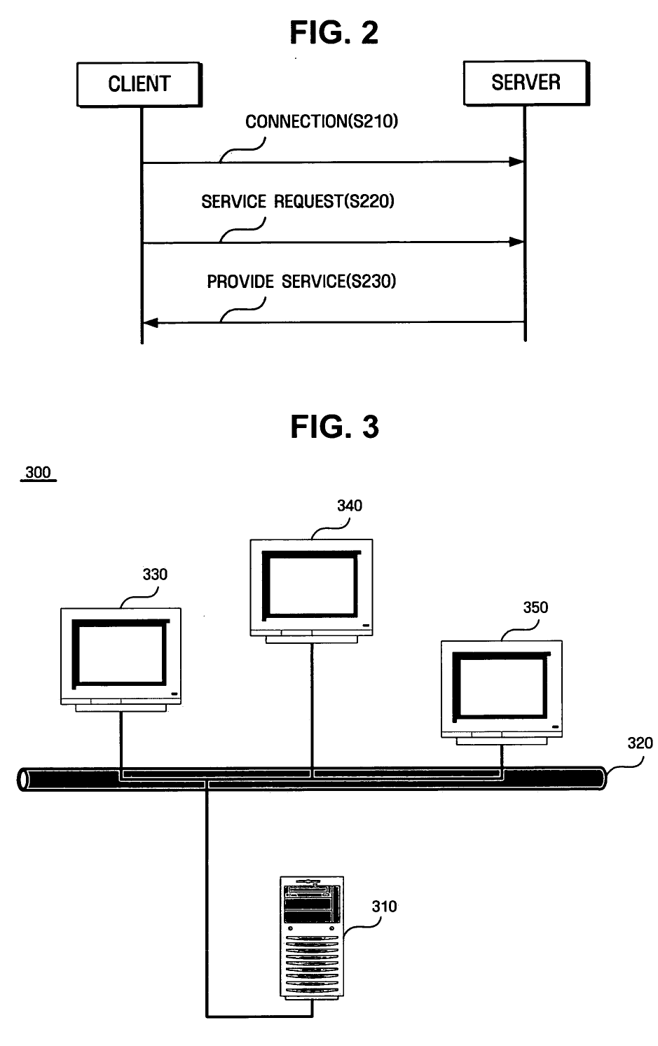

### DETAILED DESCRIPTION OF EXEMPLARY EMBODIMENTS OF THE INVENTION

The present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

The present invention is described hereinafter with reference to flowchart illustrations of methods according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to create means for implementing the functions specified in the flowchart block or blocks.

These computer program instructions may also be stored in a computer usable or computer-readable memory that can direct a computer or other programmable data processing apparatus to function in a particular manner, such that the instructions implement the function specified in the flowchart block or blocks.

The computer program instructions may also be loaded onto a computer or other programmable data processing apparatus to cause a series of operational steps to be performed on the computer or other programmable apparatus to produce a computer implemented process for implementing the functions specified in the flowchart block or blocks.

FIG. 3 is a schematic diagram of a system 300 for providing a service of displaying content according to an exemplary embodiment of the present invention. The system 300 includes a server 310, a plurality of display apparatuses 330, 340, and 350, which receive content from the server 310 and output it, and a transmission medium 320, which connects the server 310 with the plurality of display apparatuses 330, 340, and 350. Each of the display apparatuses 330, 340, and 350 may be a television, a monitor, or a large display apparatus like an electric signboard.

Unlike a conventional system, the server 310 provides content stored therein to a particular display apparatus 330, 340, or 350 according to a predetermined schedule, and the display apparatus 330, 340, or 350 receive the content and convert the format of the content into an output format that it supports. Accordingly, the display apparatuses 330, 340, and 350 are equipped with hardware or software for converting the diverse data formats of the content.

In addition, the server 310 can remotely control the display apparatuses 330, 340, and 350 and monitor state changes occurring in the display apparatuses 330, 340, and 350.

Information is transferred between the server 310 and each of the display apparatuses 330, 340, and 350 using a message communication method, which will be described later.

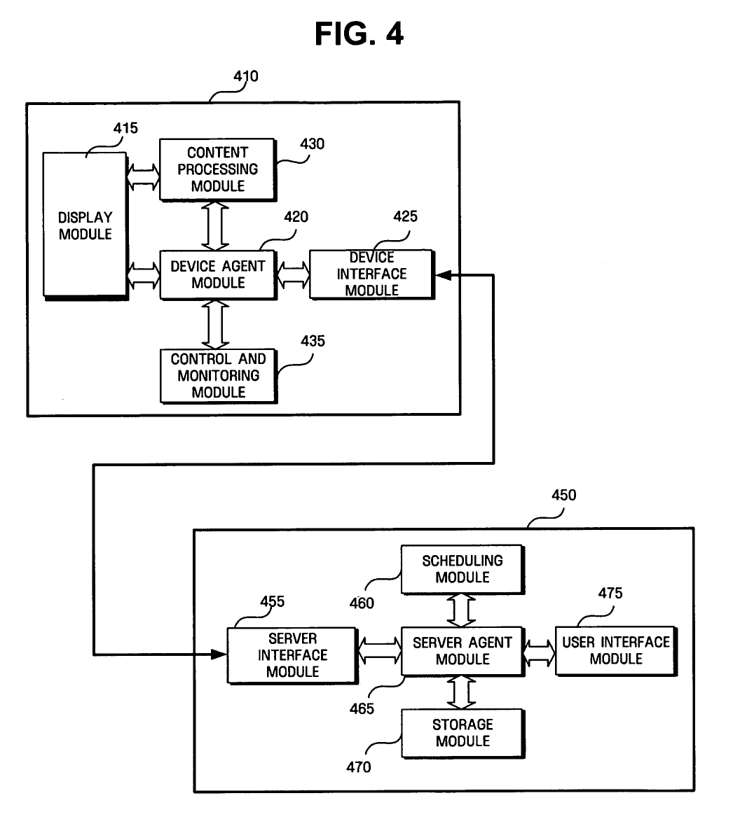

FIG. 4 illustrates a display device 410 and a server 450 for providing a service for displaying content according to an exemplary embodiment of the present invention.

The display device 410 includes a display module 415, a device agent module 420, a device interface module 425, a content processing module 430, and a control and monitoring module 435.

The display module 415 displays content received from the server, provides a user with a means to both request particular content stored in the server 450, and control the display apparatus 410. This means display device 410 may be provided as an independent module such as a device user interface module.

The device interface module 425 automatically senses another display apparatus and the server 450, which are connected thereto through a network, and extracts information on the sensed display apparatus and the server 450, and performs message communication with the sensed display apparatus or the server 450.

The content processing module 430 converts content received from the server 450 to a suitable format for the display device 410 and transmits the converted content to the display module 415.

When the display device 410 receives a control command from the server, the control and monitoring module 435 performs an operation corresponding to the message. In addition, the control and monitoring module 435 senses state changes in the display apparatus 410.

The device agent module 420 analyzes messages received through the device interface module 425 and performs operations corresponding to the messages. In addition, the device agent module 420 controls the display module 415, the control and monitoring module 435, and the content processing module 430.

The server 450 includes a server interface module 455, a scheduling module 460, a server agent module 465, a storage module 470, and a user interface module 475.

The server interface module 455 automatically senses a plurality of display apparatuses connected therewith through a network, extracts information on each sensed display apparatus, and performs message communication with the plurality of display apparatuses.

The storage module 470 stores content and schedule information, i.e., information about a schedule for automatically transmitting content (i.e., pushing content) to each of the display apparatuses. The content includes sound files such as music, image files such as photos, video files such as motion pictures, and text files having diverse formats.

The user interface module 475 allows a server manager to search for content stored in the storage module 470 using a keyword or an index, and it allows the server manager to register a schedule indicating content to be transmitted to display apparatuses at a specific times. In addition, the user interface module 475 allows the server manager to input a remote control command so that the server manager can remotely control the plurality of display apparatuses, and it shows information on state changes in the plurality of display apparatuses.

The scheduling module 460 manages the schedule information and transmits particular content to a designated display apparatus at a particular time.

The server agent module 465 analyzes messages received through the server interface module 455 and performs operations according to the messages. In addition, the server agent module 465 controls the user interface module 475, the scheduling module 460, and the storage module 470.

The term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on an addressable storage medium and to execute on one or more processors. Thus, a module may include, by way of example, components such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

Hereinafter, operations between the modules will be described in detail. For clarity, a procedure for displaying content and a procedure for remote control and monitoring will be described separately.

Content Display Service

Mutual Recognition Between a Display Apparatus and a Server

The server 450 and the display device 410 are connected to a single network through the server interface module 455 and the device interface module 425, respectively. Here, the server 450 may be connected with a plurality of display apparatuses, but for clarity, the description will be set forth with respect to a single display apparatus, and it is assumed that the structure of other display apparatuses is the same as that of the display device 410 show in FIG. 4.

The server interface module 455 and the device interface module 425 senses whether a display apparatus or a server connected thereto has been supplied with power to operate. For example, in the server 450, the server interface module 455 senses the display device 410 and transmits the sensing result to the server agent module 465. Then, the server agent module 465 provides a server manager with information on the state of the display device 410 through the user interface module 475. Accordingly, the server manager can check the states of display apparatuses at the server 450 site, without directly going to the site of each display apparatus to manually check them.

Scheduling

To display content on the display apparatus 410, a server manager searches for the content stored in the storage module 470 by inputting a keyword and an index through the user interface module 475. Next, the server manager inputs a time into the user interface module 475 when the searched content is to be displayed on the display device 410.

Information on the searched content and schedule information display device 410 are managed by the scheduling module 460. Accordingly, the scheduling module 460 transmits the schedule information to the server agent module 465 at the display time. Then, the server agent module 465 fetches the content from the storage module 470 and transmits it to the display device 410 through the server interface module 455.

Outputting of Content

When the display device 410 receives data from the server 450 through the device interface module 425, the device agent module 420 determines whether the received data is content for outputting or data for controlling the display apparatus 410.

When it is determined that the received data is content for outputting, that is, when content is transmitted from the server 450 according to the operation of the scheduling module 460, the device agent module 420 transmits the received data to the content processing module 430.

The content processing module 430 converts the data received from the device agent module 420 into a format suitable for the display device 410 and drives an application program to output the converted content. The content output through the application program is provided to a user through the display module 415.

Meanwhile, the user of the display device 410 may request particular content from the server 450 through the display module 415. In this case, the display module 415 is provided with a function allowing the user to input content information. Here, the display device 410 may receive a content list (stored in advance in the storage module 470 after being received from the server 450) and provide this content list to the user through the display module 415 at the user's request for content. Alternatively, the display device 410 may request the content list from the server 450 only in response to a user's request for content.

Application Examples

Several representative application examples of the present invention will be described below.

Electronic Art Gallery

The server 450 converts works of art possessed by an art gallery into high-definition image data and stores them in the storage module 470. The display device 410 is installed in an art gallery or a public space having a space for exhibition and connected to the server 450 through a network.

A server manager decides schedule information including the order in which images are displayed on the display device 410 and display related information through the user interface module 475 and registers the schedule information in the scheduling module 460. The scheduling module 460 transmits the schedule information to the server agent module 465 at a designated time. The server agent module 465 fetches the image data from the storage module 470 based on the schedule information and transmits the image data to the display device 410 through the server interface module 455 so that a user can view the works of art.

Airport Information Service

The server 450 stores an airport guide, airline information, advertisements, entertainment video/audio content, and other information in the storage module 470. The display device 410 is installed at a desired place within an airport and connected to the server 450 through a network.

The scheduling module 460 of the server 450 manages the order and content of information to be provided to the display apparatus 410. The server transmits particular content to the display device 410 at a predetermined time. The display device 410 receives the content, converts it into an appropriate format, and displays it on a screen.

Information Presentation Service

The server 450 stores guide and presentation content in the storage module 470. The display device 410 is installed at a desired place in a public space and is connected to the server 450 through a network.

The scheduling module 460 of the server 450 manages the order and composition of the guide and presentation content to be provided to the display apparatus 410. The server transmits particular content to the display device 410 at a predetermined time. The display device 410 receives the content, converts it into an appropriate format, and displays it on a screen.

Remote Control and Monitoring

The server 450 can remotely control the display device 410 according to the state of the display apparatus 410. For remote control operation, the server 450 and the display device 410 use a remote control message set and the display device 410 includes the control and monitoring module 435 for such purposes.

For example, when a server manager wants to turn on or off the power of the display device 410 or control an output state such as the volume or contrast, the server manager inputs a control command through the user interface module 475. Here, the user interface module 475 provides the server manager with a user interface for controlling the display apparatus 410.

In addition, the server 450 can remotely command navigation motions such as stop, pause, forward, and backward with respect to content output by the display apparatus 410.

At the same time, the control and monitoring module 435 of the display device 410 senses state changes and transmits information on the sensed state change to the device agent module 420. The device agent module 420 transmits this information to the server 450 through the device interface module 425. As a result, the server 450 can remotely monitor the state of the display apparatus 410.

The detailed description of remote control and monitoring display device 410 will be set forth later.

Message communication is performed between the display device 410 and the server 450, and this is described in detail below. For clarity, the display device 410 is referred to as a client 410 and is described with reference to FIG. 4. The server agent module 455 in the server 450 and the device agent module 420 in the client 410 perform operations of generating a packet and analyzing a received message in order to accomplish message communication.

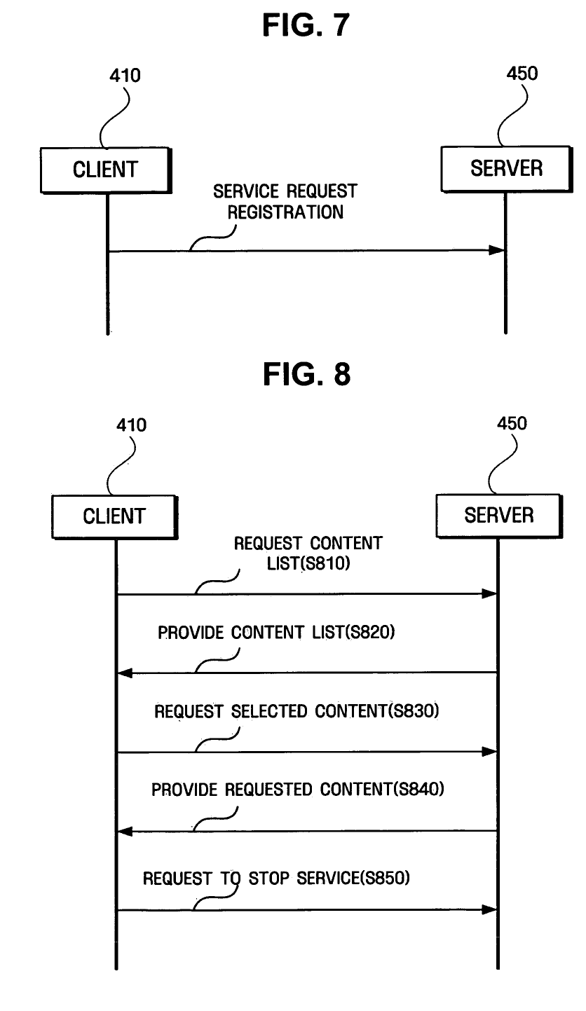

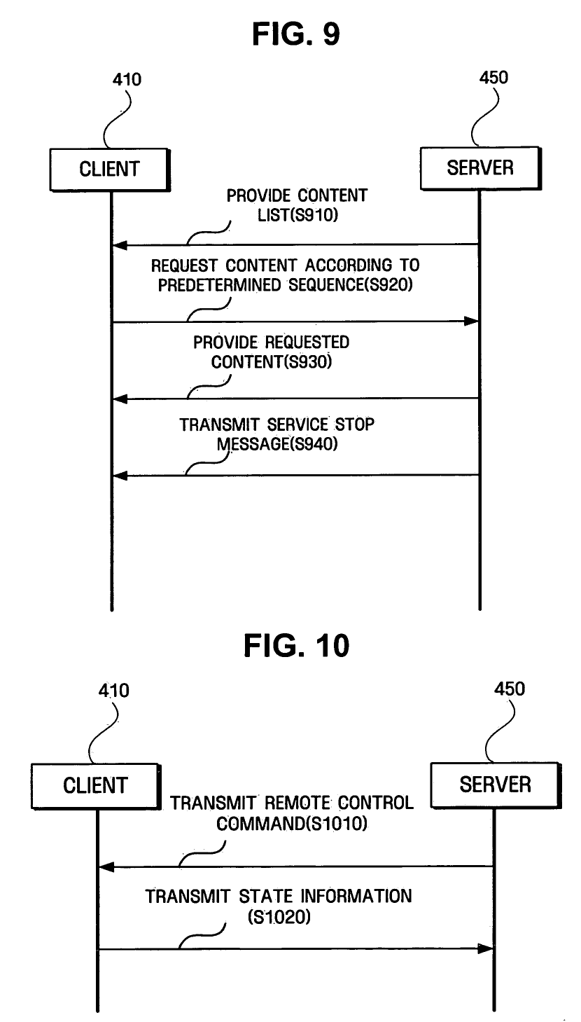

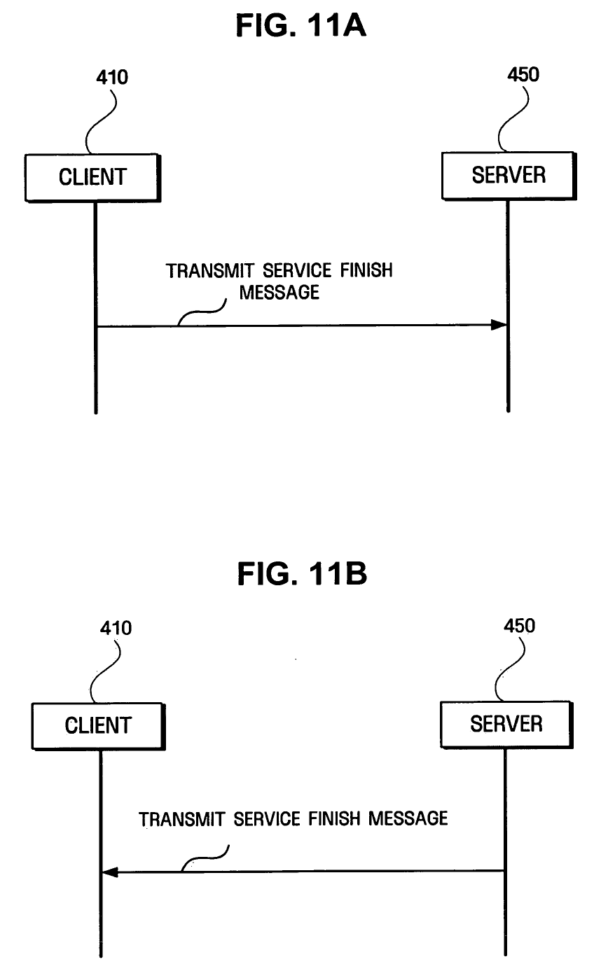

A message communication protocol according to an exemplary embodiment of the present invention is largely divided into message communication for: registering a client as a service target in order to start a service (see FIG. 7), initiating a pull mode of service of the server (see FIG. 8), initiating a push mode service from the server to the client (see FIG. 9), remote control operation performed by the server with respect to the client (see FIG. 10), finishing a service between the server and the client (see FIGS. 11A and 11B).

An example of the pull mode of service is a server that provides music, and a client selects a desired music title from a list of music titles stored in the server and receives the desired music title from the server.

An example of the push mode of service, monitors supporting a network function are installed at many places in a waiting room of a bus terminal or a train station, and a server provides the monitors with departure and arrival times of trains or buses, announcements, movies, and music.

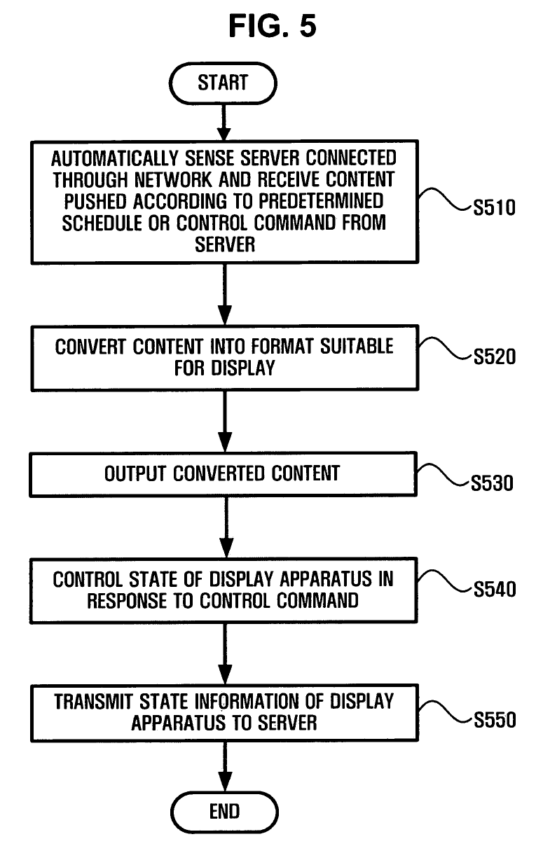

FIG. 5 is a schematic flowchart of a procedure performed by the display device 410 to display content, according to an exemplary embodiment of the present invention.

In operation S510, the device interface module 425 of the display device 410 automatically senses other display apparatuses and a server which are connected thereto through a network, extracts information about both the sensed display apparatuses and the sensed server, and receives content that is automatically transmitted, i.e., pushed by the sensed server according to a schedule predetermined by a server manager or a control command from the server. In operation S520, the content processing module 430 converts the content received from the server into an output format supported by the display apparatus 410. In operation S530, the display module 415 displays the converted content.

In operation S540, the control command received by the device interface module 425 is executed by the control and monitoring module 435 to control the state of the display apparatus 410. In operation S550, the display device 410 transmits state information of the display apparatus 410, i.e., information on the result of executing the control command or information on an output state of the content, to the server. Consequently, the server can remotely control and monitor the display apparatus 410.

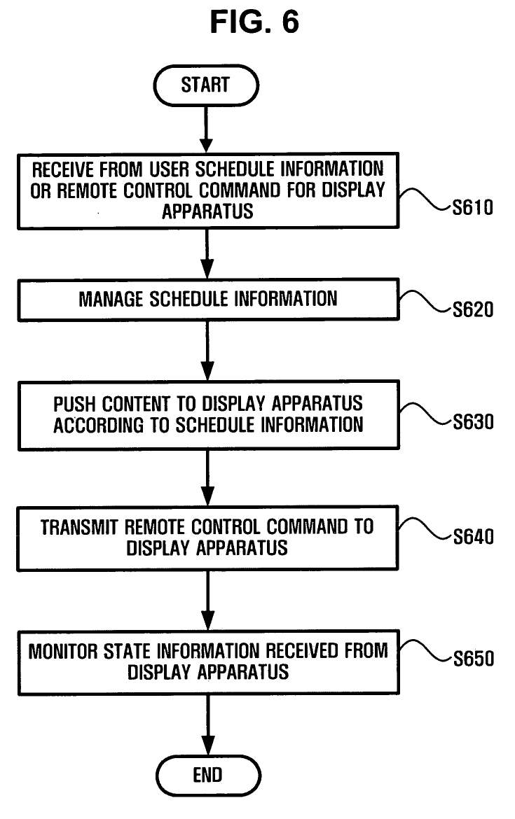

FIG. 6 is a schematic flowchart of a procedure performed by the server 450 to display content, according to an exemplary embodiment of the present invention.

In operation S610, the server receives either schedule information from a server manager that indicates a schedule for pushing content to a display apparatus or a remote control command for the display apparatus through the user interface module 475. In operation S620, the scheduling module 460 manages the schedule information input by the server manager. In operation S630, the server agent module 465 pushes particular content to the display apparatus at a specific time according to the schedule information. In operation 640, the server agent module 465 transmits a control command to remotely control the display apparatus. The display apparatus transmits state information regarding the outputting of content or the result of executing the control command to the server 450 periodically or when an event occurs, and the server 450 monitors this state information in operation S650.

FIG. 7 illustrates a service registration procedure according to an exemplary embodiment of the present invention. In the service registration procedure, the client 410 sends information to the server to register itself and to use a service provided by the server 450.

Here, a packet used for the service registration includes a media access control (MAC) address, a service type, a group name, and a client name.

The MAC address is a unique identification number allocated to a network card included in the device interface module 425 that is used as an identifier for the client 410. In addition, the MAC address can also be used when the server turns on the power of the client 410 in remote control operation.

The service type is a unique identifier for identifying a service of a different server.

The group name is the name of a group including the client 410 and it is used to manage a plurality of clients in groups.

The client name is an alias of the client 410, which is familiar to a user, and is used to identify the client 410.

When the client 410 sends a service registration request to the server 450, as shown in FIG. 7, the server agent module 465 checks the service type and the group name. If the service type is supported by the server 450 and the group name corresponds to a group managed by the server 450, the server agent module 465 stores information about the client 410 that requested registration in the storage module 470. Here, the server 450 may be set to manage the list of registered clients by groups and to provide a service to a particular group or to clients in all groups.

FIG. 8 illustrates a procedure for performing a pull mode of service according to an exemplary embodiment of the present invention. When the client 410 uses content selected from a content list provided by the server 450, the pull mode of service is performed.

Packets used for the pull mode of service include: a content list request packet containing a service type, a group name, a client name, a media type, list sorting information, and list request information; a content list packet containing a service type, a server name, a media type, content list information, and server service network information; a content request containing a service type, a group name, a client name, and content information; and a content finish packet containing a service type, a group name, a client name, and a media type. Here, the media type indicates a type of media, such as movies, music, photos, or document files, corresponding to relevant content.

The list sorting information indicates parameter information such as a name, a date, a file size, or a genre by which content is sorted in a list.

The list request information indicates the number of lists per page and the position of a page.

The content list information indicates a list of content information, i.e., a content list for a particular media type.

The server service network information is information on a network connection through which the server 450 provides a service which may include an Internet Protocol (IP) address and a port number.

When a multicast type of service is required, the server service network information may further include an IP address and a port number for multicasting.

The content information is information about the content and it may include a file name, a file length, a creation date, a genre, a running time, and image thumbnails.

Referring to FIG. 8, in operation S810, the device agent module 420 of the client 410 requests a content list for particular media from the server 450 through the device interface module 425 (a pull mode of service). Here, the client 410 transmits a pull mode content list request packet to the server 450.

The server agent module 465 checks whether the requested service type is supported by the server 450 and whether the client 410 is a member of an authorized group.

Thereafter, in operation S820, the server agent module 465 retrieves content corresponding to the particular media from the storage module 470, creates a content list, and transmits this content list to the client 410 using a pull mode content list packet.

In operation S830, the client 410 selects desired content from the content list and requests this selected content from the server 450 using a pull mode content request packet.

In operation S840, the server 450 checks whether the requested service type is supported and whether the client 410 is an authorized client, and transmits the requested content. When the client 410 wants to stop the pull mode of service, the client 410 transmits a pull mode content finish packet to the server 450 in operation S850.

FIG. 9 is illustrates a procedure for performing a push mode of service according to an exemplary embodiment of the present invention. The push mode of service may be used when the server 450 provides content to the client 410 when directed by the scheduling module 460.

Here, packets used for the push mode service include a push mode content list packet containing a service type, a server name, a media type, content list information, and server service network information; a push mode content request packet containing a service type, a group name, a client name, and content information; and a push mode content finish packet containing a service type, a server name, and a media type.

Referring to FIG. 9, in operation S910, the server 450 transmits a content list to the client 410 connected thereto (a push mode of service). Here, a push mode content list packet is used.

In operation S920, the client 410 requests the server 450 to transmit content from the content list according to a predetermined sequence by sending a push mode content request packet.

In operation S930, the server 450 checks whether the requested service type is supported and whether the client 410 is an authorized client and transmits the requested content.

Operations S920 and S930 are repeated until all content on the content list is sent to the client 410.

In operation S940, the server 450 can stop the push mode of service by transmitting a push mode content finish packet to the client 410.

FIG. 10 illustrates a procedure for performing a remote control service according to an exemplary embodiment of the present invention. The remove control service can be used when the server 450 remotely controls a video or audio mode of the client 410 and remotely monitors the state of the client 410.

Packets used for the remote control service include: a remote control packet containing a service type, a server name, a remote control command, and a remote control command parameter; and a client state packet containing a service type, a server name, and client state information.

Here, the remote control command indicates a control executed by the server 450 with respect to the client 410. For example, the remote control command may be: Power On/Off, Wake up LAN, Adjust Contrast, Adjust Tint, Adjust Brightness, Adjust Volume, Adjust Video Mode, or Adjust Audio Mode. The Wake up LAN is a process of multicasting MAC address information of a network card to a local LAN and turning on the power of a CPU connected to the network card.

The client state information is state information including volume, a video mode, an audio mode, contrast, tint, and brightness of the client 410.

In the remote control service shown in FIG. 10, in operation S1010 the server 450 transmits a remote control command to the client 410 using a remote control packet.

The device agent module 420 of the client 410 analyzes this packet to determine whether the packet is involved in the remote control service. When it is determined that the packet is involved in the remote control service, the device agent module 420 transmits the remote control command to the control and monitoring module 435. The control and monitoring module 435 executes the remote control command and reports a changed state resulting from this execution to the device agent module 420. In operation S1020, the device agent module 420 transmits this changed state to the server 450 through the device interface module 425 using a client state packet.

FIGS. 11A and 11B illustrate procedures for finishing a service according to an exemplary embodiment of the present invention. A service finishing procedure may be performed when the client 410 or the server 450 inform each other of completion of the service. Packets used to finish service include: a client service finish packet containing an MAC address, a service type, a group name, and a client name; and a server service finish packet containing a service type, and a server name.

The procedure shown in FIG. 11A is performed when the client 410 finishes the service. Referring to FIG. 11A, the client 410 transmits a “client service finish packet” to the server 450.

The procedure shown in FIG. 11B is performed when the server 450 finishes the service. Referring to FIG. 11B, the server 450 transmits a server service finish packet to the client 410. Here, the server 450 transmits a service finish message to every client connected thereto.

In addition, a message for periodically checking whether the server 450 and the client 410 are connected to each other can be transmitted and received therebetween. By using this message, the server 450 and the client 410 can recognize abnormal stops in service. A packet used to check the connection between the server 450 and the client 410 has an MAC address, a service type, a group name, and a client name.

A system for displaying content according to an exemplary embodiment of the present invention allows a plurality of display apparatuses to receive content from a single server and to display that content, and it also allows the server to control the display apparatuses and monitor state changes occurring in the display apparatuses. In other words, according to the present invention, a display apparatus not only outputs content but also executes various functions by communicating with the server as described above.

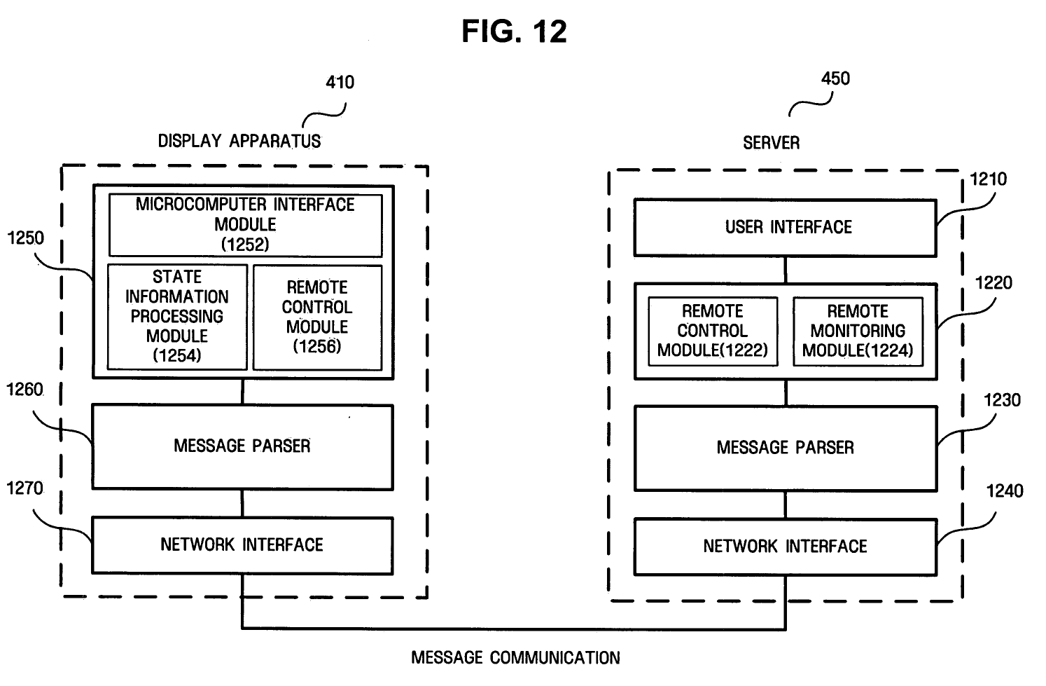

FIG. 12 is a block diagram of a remote control and monitoring system according to an exemplary embodiment of the present invention.

For remote control and monitoring, a server 450 contains a user interface 1210, a server remote control and monitoring module 1220 including a remote control module 1222 and a remote monitoring module 1224, a message parser 1230, and a network interface 1240.

The user interface 1210 is produced by the user interface module 475 shown in FIG. 4 to provide an interface allowing a server manager to control a display device 410 and to know state information of the display apparatus 410.

The message parser 1230 generates a message for controlling the display device 410 and analyzes a message regarding state information received from the display apparatus 410. The functions of the message parser 1230 can be performed by the server agent module 465 shown in FIG. 4.

The remote control module 1222 transmits control information received from the user interface 1210 to the message parser 1230. The remote monitoring module 1224 transmits state information of the display apparatus 410, which is analyzed by the message parser 1230, to the user interface 1210.

The remote control module 1222 and the remote monitoring module 1224 may be included in the server agent module 465 or the user interface module 475.

The network interface 1240 of the server 450 can be provided by the server interface module 455 shown in FIG. 4.

The client control and monitoring module 1250 of the display device 410 includes a microcomputer interface module 1252, a state information processing module 1254, and a remote control module 1256, a message parser 1260, and a network interface 1270.

The network interface 1270 of the display device 410 can be provided by the device interface module 425 shown in FIG. 4.

The message parser 1260 generates a message including state information of the display device 410 or event information, and analyzes control information received from the server 450. The functions of the message parser 1260 may be performed by the device agent module 420 shown in FIG. 4.

The remote control module 1256 transmits the control information the microcomputer interface module 1252. The state information processing module 1254 senses events or state changes occurring in the display device 410 display device 410 transmits to the message parser 1260.

The microcomputer interface module 1252 controls the hardware elements of the display apparatus 410. The microcomputer interface module 1252 receives control information from the remote control module 1256 and controls relevant hardware element(s) accordingly.

The remote control module 1256, the state information processing module 1254, and the microcomputer interface module 1252 may be included in the control and monitoring module 435 shown in FIG. 4.

The remote control and monitoring function performed with respect to the display device 410 will be separately described in the following in terms of: remote control of the display device 410 by a server manager, and monitoring of a state change in the display apparatus 410.

Remote Control of the Display Apparatus 410 by a Server Manager

For example, when turning off the power of the display apparatus 410, the server manager checks the power states of display apparatuses through the user interface 1210 provided by the user interface module 475.

When the server manager requires the display device 410 to be turned off; the remote control module 1222 receives and transmits the selection of the server manager to the message parser 1230. The message parser 1230 creates a message for remote control and transmits the message to the display device 410 through the network interface 1240 of the server 450.

The display device 410 receives the message through the network interface 1270. The message parser 1260 analyzes the received message and transmits the analyzed information to the remote control module 1256. Since the operation of turning on or off the power corresponds to a control over hardware elements, the remote control module 1256 drives the microcomputer interface module 1252 to turn off the power of the display apparatus 410.

Through such operations the volume, contrast, brightness, monitor input, and other attributes of the display apparatuses can be adjusted.

Monitoring of a State Change in the Display Apparatus 410

State changes in the display device 410 include state changes resulting from remote control of the display device 410 and state changes display device 410 when independent of control by the server 450. When a state change results from remote control of the display apparatus 410, e.g., when the power state changes due to a power on/off from the server 450, the state information processing module 1254 senses the changed state and transmits it to the message parser 1260. The message parser 1260 creates a message indicating state information and transmits the message to the server 450 through the network interface 1270.

The server 450 receives the message through the network interface 1240. The message parser 1230 analyzes the received message and transmits analyzed information to the remote monitoring module 1220. The remote monitoring module 1220 provides information on the state change to a server manager through the user interface 1210.

When a state change occurs in the display device 410 when independent of control by the server 450, the server 450 may periodically receive state information from all display apparatuses connected thereto via a network. The state information may include a list of connected display apparatuses, a network connection state of each display apparatus, and a current service status of each display apparatus. In addition, the display device 410 screen can be displayed on the server 450. Furthermore, the server 450 may set the display device 410 to automatically operate to cope with a major event occurring in the display apparatus 410.

In conclusion, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

An apparatus and method for displaying content according to the present invention may provide the following advantages.

First, content is automatically provided by a server to a plurality of display apparatuses having message communication functionality that can be controlled by predetermined schedule information. Accordingly, content can be displayed without user management.

Second, the plurality of display apparatuses can be remotely controlled and changes in the physical state of each display apparatus can be monitored using the single server.

What is claimed is:

1. A display apparatus for displaying content, the display apparatus comprising:
a device interface module that automatically senses a server connected to the display apparatus through a network, and receives content pushed according to a predetermined schedule or a control command from the server;
a control and monitoring module that senses a state change, receives the control command from the device interface module and performs state control corresponding to the control command;
a content processing module that converts the content received from the device interface module into a format suitable for display;
a display module that outputs the content converted by the content processing module; and
a device agent module that analyzes information received through the device interface module and performs an operation according to the information which is analyzed.

2. The display apparatus of claim 1, further comprising a device user interface module that provides a user interface allowing to both input a control command for the display apparatus and to select content to be received from the server.

3. The display apparatus of claim 1, wherein the control command is for controlling at least one of power on or off of the display apparatus, an output state of the display apparatus, and navigation during output of the content.

4. The display apparatus of claim 1, wherein the device agent module requests the server to transmit specific content from the content stored in the server.

5. The display apparatus of claim 1, wherein the content processing module decodes the content received from the device interface module and drives an application program for outputting the content which is converted by the content processing module.

6. The display apparatus of claim 1, wherein information on the state change sensed by the control and monitoring module comprises at least one of information on how the display apparatus uses the network, information on an operating mode of the display apparatus, information on the content that is output by the display apparatus, and information on a result of executing the control command.

7. A server apparatus comprising:
a server interface module that automatically senses a display apparatus connected to a server through a network, extracts information on the display apparatus, and transmits to the display apparatus both content and a control command for controlling the display apparatus;
a storage module that stores the content and schedule information;
a scheduling module that manages the schedule information and pushes the content to the display apparatus according to the schedule information;
a user interface module that provides a user interface to input the schedule information and the control command for the display apparatus; and
a server agent module that analyzes information provided through the server interface module, performs an operation according to the information which is analyzed, and monitors state information received from the display apparatus.

8. The server apparatus of claim 7, wherein the user interface module manages information on the content stored in the storage module and searches for the content using the information on the content.

9. The server apparatus of claim 7, wherein the server agent module transmits content requested by the display apparatus.

10. The server apparatus of claim 7, wherein the control command is for controlling at least one of power on or off of the display apparatus, an output state of the display apparatus, and navigation during output of the content by the display apparatus.

11. The server apparatus of claim 7, wherein the state information comprises at least one of information on how the display apparatus uses the network, information on an operating mode of the display apparatus, information on the content that is output by the display apparatus, and information on a result of an operation performed by the display apparatus according to the control command.

12. A method of displaying content, the method comprising:
automatically sensing a server connected through a network and receiving one of content pushed according to a predetermined schedule and a control command from the server;
converting the content which is received into a format suitable for display;
outputting the content which is converted;
performing state control according to the control command which is received; and
transmitting state information comprising one of a result of performing the state control and information on an output state of the content.

13. A method of displaying content, the method comprising:
receiving one of schedule information and a control command for the display apparatus;
managing the schedule information;
pushing the content to the display apparatus according to the schedule information;
transmitting the control command to the display apparatus; and
monitoring state information received from the display apparatus, the state information comprising one of a result of executing the control command and information on an output state of the content.

14. A recording medium having a computer readable program recorded therein, the program for executing a method of displaying content, the method comprising:
automatically sensing a server connected through a network and receiving one of content pushed according to a predetermined schedule and a control command from the server;
converting the content which is received into a format suitable for display;
outputting the content which is converted;
performing state control according to the control command which is received; and
transmitting state information comprising one of a result of performing the state control and information on an output state of the content.

15. A recording medium having a computer readable program recorded therein, the program for executing a method of displaying content, the method comprising:
receiving one of schedule information and a control command for the display apparatus;
managing the schedule information;
pushing the content to the display apparatus according to the schedule information;
transmitting the control command to the display apparatus; and
monitoring state information received from the display apparatus, the state information comprising one of a result of executing the control command and information on an output state of the content.
